(19) United States
(12) Patent Application Publication
(10) Pub. No.: US 2009/0277149 A1
(43) Pub. Date: Nov. 12, 2009

(54) HIGH LIFT MOWER FOR PLASTIC MULCH

(75) Inventor: James R. Adkins, Parsonsburg, MD (US)

Correspondence Address: RATNERPRESTIA, P.O. BOX 1596, WILMINGTON, DE, 19899, US

(73) Assignee: University of Delaware, Newark, DE (US)

(21) Appl. No.: 12/436,331

(22) Filed: May 6, 2009

Related U.S. Application Data
(60) Provisional application No. 61/051,029, filed on May 7, 2008.

(51) Int. Cl. A01D 34/74; A01D 34/82; A01D 34/73; A01D 34/64; A01D 67/00; A01D 75/00

(52) U.S. Cl. 56/255; 56/295; 56/229

(57) ABSTRACT

A high-lift mower is disclosed. The mower includes a frame, at least two wheels disposed along opposite sides of the frame and having a space between them, and a blade rotation mechanism, mounted to the frame, for providing a rotational force relative to the frame. A blade assembly is coupled to the blade rotation means. The blade assembly comprises a plurality of cutting blades. Each of the plurality of blades includes a front face having a cutting blade and a rear face disposed away from the front face. The rear face has a lift portion. A roller assembly is adjustably coupled to the frame for, upon engagement with a surface located in the space between the pair of wheels, maintaining the blade assembly a predetermined distance above the surface. A blade assembly and a roller assembly for use with the high-lift mower are also disclosed.

### CROSS-REFERENCE TO RELATED APPLICATION

The present application claims priority from U.S. Provisional Patent Application Ser. No. 61/051,029, filed on May 7, 2008, which is incorporated herein by reference in its entirety.

### BACKGROUND OF THE INVENTION

The commercial fresh market vegetable industry has widely adopted plastic mulch for the planting of vegetable crops. Using plastic mulch entails laying a thin (about 0.6 mil-about 1.5 mil) strip of plastic on top of a planting bed and mechanically tucking the edges under the soil to prevent wind damage. Holes are cut or punched into the plastic for vegetable seeds or transplants to be inserted into the bed. The plastic mulch provides more favorable growing conditions over bare ground production due to increased soil temperatures, water retention, and weed suppression.

One of the biggest challenges to vegetable production on plastic mulch, however, is the recovery and disposal of the plastic at the end of the growing season. Recovery of the plastic requires the mowing of the crop to reduce the vegetation that will severely hinder removal. Typically, a rotary mower is used to crop the vegetation. This method however, is not ideal. The height of a mounted mower above the plastic is determined by setting the tractor hitch on which the mower is mounted. As the tractor travels along the bed, any small bump encountered by the tractor is translated into a large movement of the mower. Such movement can cause the mower to dive into the plastic, which can rip the plastic and can also be detrimental to the mower and plastic recovery effort. Further, the mowed vegetation is oftentimes deposited back on top of the plastic, further hindering removal of the plastic on the bed.

There exists a need to develop a mower that cleanly cuts and removes the vegetation from the bed, while minimizing any adverse impact on the plastic.

### SUMMARY OF THE INVENTION

Briefly, the present invention provides a high-lift mower comprising a frame, at least two wheels disposed along opposite sides of the frame and having a space between them, and a blade rotation means, mounted to the frame, for providing a rotational force relative to the frame. A blade assembly is coupled to the blade rotation means. The blade assembly comprises a plurality of cutting blades. Each of the plurality of blades includes a front face having a cutting blade and a rear face disposed away from the front face. The rear face has a lift portion. A roller assembly is adjustably coupled to the frame for, upon engagement with a surface located in the space between the pair of wheels, maintaining the blade assembly a predetermined distance above the surface.

The present invention also provides a high-lift mower blade comprising a first end portion-adapted to be coupled to a mower. A middle portion extends downward from the first end portion at an oblique angle relative to the first end portion. A second end portion extends obliquely away from the middle portion and generally parallel to the first end portion. The second end portion comprises a front face having a cutting blade and a rear face including a lift portion that extends upwardly therefrom.

The present invention also provides a roller assembly for mounting to a frame of a high-lift mower. The mower comprises the frame, one or more rotating blades mounted beneath the frame, and at least two wheels disposed along opposite sides of the frame and spaced apart from one another a first distance sufficient to accommodate a raised bed surface between them. The roller assembly comprises one or more arms for coupling to the frame, a horizontal support bar coupled to the one or more arms, and a roller rotatably coupled to the support bar for engaging the raised bed surface. A height adjustment mechanism varies a height of the roller relative to the rotating blades for setting a minimum distance between the raised bed surface and the rotating blades.

### BRIEF DESCRIPTION OF THE DRAWINGS

The foregoing summary, as well as the following detailed description of an exemplary embodiment of the invention, will be better understood when read in conjunction with the appended drawings, which are incorporated herein and constitute part of this specification. For the purposes of illustrating the invention, there are shown in the drawings exemplary embodiments of the invention. It should be understood, however, that the invention is not limited to the precise arrangements and instrumentalities shown. In the drawings, which are not drawn to scale, the same reference numerals are employed for designating the same elements throughout the several figures. In the drawings:

FIG. 1 is a front perspective view of a mower according to an exemplary embodiment of the present invention;

FIG. 2 is a perspective view of a rear portion of the mower of FIG. 1;

FIG. 3 is a rear perspective view of the mower of FIG. 1, showing the mower over a raised vegetable bed;

FIG. 4 is a perspective view of a pair of blades used in a blade assembly for the mower of FIG. 1;

FIG. 5 is an enlarged view of a free end of one of the blades shown in FIG. 4;

FIG. 6 is a perspective view of an alternative embodiment of a mower body according to an exemplary aspect of the present invention; and

FIG. 7 is a side elevational view, in section, of a roller height adjustment device used with the mower of either of FIG. 1 or 6.

### DETAILED DESCRIPTION OF THE INVENTION

Certain terminology is used herein for convenience only and is not to be taken as a limitation on the present invention. The terminology includes the words specifically mentioned, derivatives thereof and words of similar import. Features of exemplary embodiments of this invention will now be described with reference to the figures. It will be appreciated that the spirit and scope of the invention is not limited to the embodiments selected for illustration. Also, it should be noted that the drawings are not rendered to any particular scale or proportion. It is contemplated that any of the configurations and materials described hereafter can be modified within the scope of this invention.

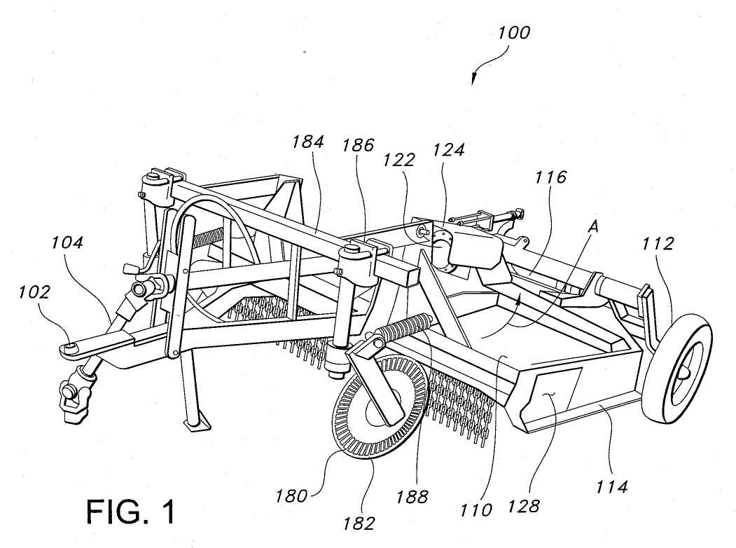

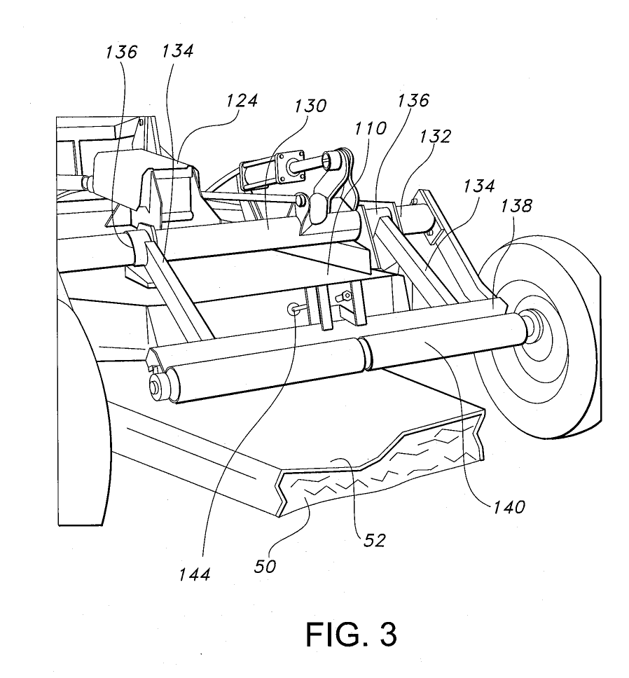

Referring to FIGS. 1-3, a high-lift mower 100 according to an exemplary embodiment of the present invention is shown. FIG. 3 illustrates mower 100 disposed over a raised bed 50 that is covered by a layer of protective plastic mulch 52. Mower 100 is used to cut and remove dead and/or unwanted vegetation from bed 50 while minimizing or eliminating the tearing of protective plastic mulch 52 over bed 50.

Mower 100 may be self-propelled or, in the embodiment shown in the figures, may be pulled by a self-propelled vehicle, such as a tractor (not shown). Mower 100 may be coupled to the tractor by a hitch 102. A coupling 104, such as a universal joint, which is known in the art, may be used to provide power from the tractor to mower 100.

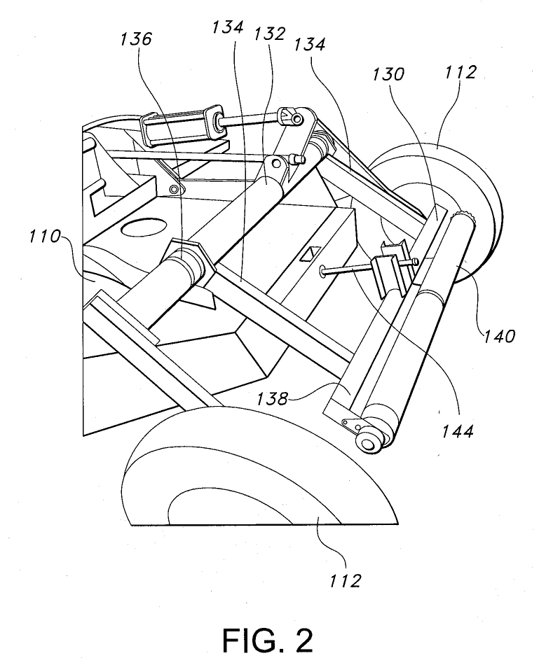

Referring specifically to FIG. 1, mower 100 consists of a deck, or frame 110, supported by a pair of wheels 112 (shown in FIG. 2) that are disposed along each of two lateral sides 114 of frame 110 (only one lateral side 114 shown in figures), generally toward the rear 116 of frame 110. The pair of wheels 112 and the hitch 102 make up a 3-point mounted mower.

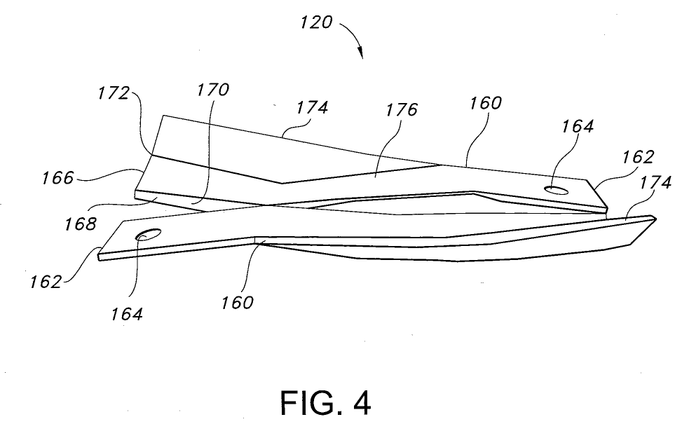

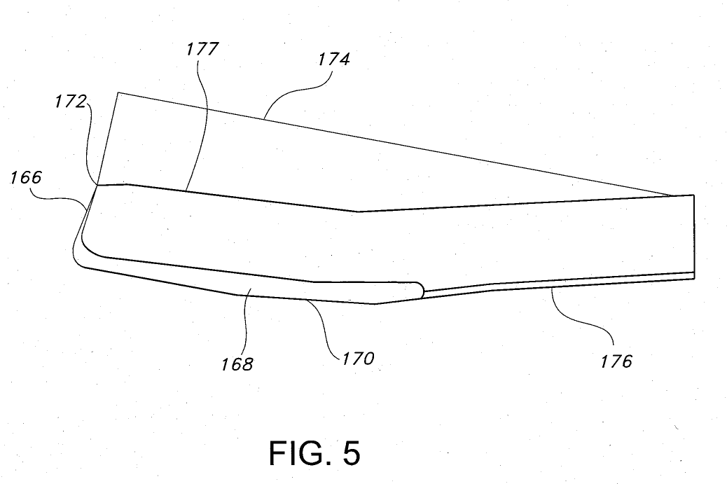

A cutting blade assembly 120, shown in detail in FIGS. 4 and 5 is rotatably mounted to an underneath portion of frame 110. Blade assembly 120 is operationally coupled to coupling 104 via a transfer mechanism, such as a bevel gear 122, that translates horizontal rotational power from coupling 104 to a vertical rotational power for blade assembly 120. A gear housing 124 covers bevel gear 122 to reduce the likelihood of dirt or other debris entering bevel gear 122 and also to reduce the risk of personal injury.

In mower 100, blade assembly 120 rotates in the direction of arrow “A” as shown in FIG. 1. Lateral side 114 includes an opening 128 through which vegetation cut by blade assembly 120 is discharged from mower 100.

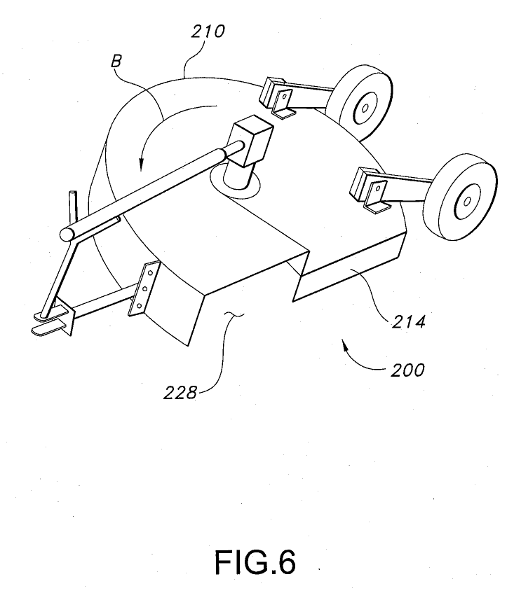

An alternative embodiment of a mower 200, shown in FIG. 6, provides an involute- or helically-shaped deck or frame 210 that is believed to aid in the discharge of cut vegetation from an opening 228 in sidewall 214. In mower 200, cutting blades (not shown) rotate in the direction of arrow “B”.

Referring to FIGS. 2 and 3, a roller assembly 130 is pivotally mounted to frame 110. Roller assembly 130 helps to maintain the height of blade assembly 120 over raised bed 50 so that blade assembly 120 does not tear into plastic mulch 52 as mower 100 is pulled over raised bed 50. In a conventional mower, the tearing of the plastic mulch often results in the mulch wrapping around the blade drive shaft. The use of roller assembly 130 reduces the likelihood of tearing plastic mulch 52 as mower 100 rolls over raised bed 50.

Roller assembly 130 includes a support member 132 that includes a pair of arms 134 pivotally coupled to frame 110 at bearings 136. Arms 134 are fixedly coupled to horizontal support bar 138 that rotatably supports a roller 140. Although shown with a pair of arms 134, roller assembly 130 may comprise more than two arms 134, or even a single arm between frame 110 and support bar 138.

Roller 140 is disposed behind frame 110 such that, as mower 100 is pulled along bed 50, roller 140 rolls along atop of bed 50 or, if roller 140 only occasionally contacts bed 50, when roller 140 does contact bed 50, maintains a minimum distance between bed 50 and blade assembly 120. For example, in a standard application for the subject invention, wheels 112 of mower 100 typically roll within ruts located on either side of a raised bed. Along a portion of a raised bed in which the height of the bed above the ruts is greater than the set distance between the bottom of wheels 112 and the bottom of blade assembly 120, roller 140 will contact bed 50 and maintain a minimum distance between the raised bed surface and blade assembly 120. Along a portion of the raised bed 50 in which the height of bed 50 above the ruts is the set distance or less between the bottom of wheels 112 and the bottom of blade assembly 120, roller 140 will not contact the top of bed 50. Thus, in practice, in some fields roller 140 may constantly contact bed 50, while in others, roller 140 may not contact bed 50 except when wheels 112 hit occasional depressions in the ruts or bed 50 has occasional high spots.

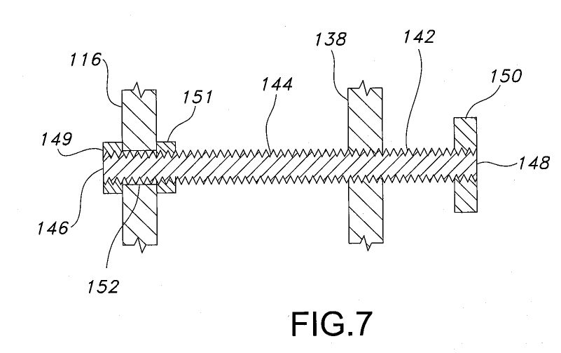

Roller assembly 130 includes a height adjustment mechanism 142, shown in FIG. 7, that may infinitely adjust the height of roller 140 (within a range of minimum to maximum height) relative to blade assembly 120. Height adjustment mechanism 142 includes a threaded rod 144 that includes a first end 146 rotatably coupled to rear 116 of frame 110 and a second end 148 that is threadably coupled to support bar 138. Nuts 149, 151 may be fixedly coupled to first end 146 of threaded rod 144 such that rear 116 of frame 110 is sandwiched between nuts 149, 151. An opening 152 in rear 116 of frame 110 has a diameter sufficiently larger than the diameter of threaded rod 144 in order to allow threaded rod 144 to freely rotate within opening 152. Second end 148 may include a nut 150 fixedly coupled thereto to assist in rotating threaded rod 144 relative to support bar 138.

Rotation of threaded rod 144 allows for an infinite adjustment of roller assembly 130 (within the range of minimum to maximum height) relative to blade assembly 120 by allowing support bar 138 to traverse along threads of threaded rod 144 as threaded rod 144 is turned. Arms 134 pivot about frame 110 to allow support bar 138 to be adjusted.

Referring to FIGS. 4 and 5, blade assembly 120 includes a plurality of blades 160 that are fixedly coupled to an output end of bevel gear 122 for rotation within frame 110. Two blades 160 are shown in FIG. 4. Each blade 160 includes a first end portion 162 that includes a mounting hole 164 for mounting blade 160 to output of bevel gear 122, such as by a bolt (not shown). A second end portion 166 of blade 160 includes a front face 168 that includes a cutting blade 170. Second end portion 166 also includes a rear face 172 having a lift portion 174. A middle portion 176 of blade 160 connects first end portion 162 to second end portion 166. When blade 160 is mounted on frame 110, first end portion 162 extends generally parallel to top deck 118 of frame 110. Middle portion 176 extends obliquely downward, away from top deck 118, at an angle of between about 5 and about 15 degrees from first end portion. Second end portion 166 extends generally parallel to both first end portion 162 and top deck 118 of frame 110. Lift portion 174 also extends along rear of middle portion 176 toward first end portion 162.

Lift portion 174 assists in developing a vacuum effect inside frame 110 to lift vegetation from plastic mulch 52 and to then cut the vegetation with cutting blades 170. Cut vegetation is then discharged from within frame 110 through opening 128 in side 114. The resulting bed 50 is relatively devoid of vegetation.

An enlarged view of second end portion 166 is shown in FIG. 5. While second end portion 166 and lift portion 174 are shown in FIG. 5 as each having flat faces that linearly intersect along line 177, those skilled in the art will recognize that blade 160 may include a curved second end portion that includes a generally curved profile, blending the second end portion into the lift portion.

Optionally, as shown in FIG. 1, mower 100 may include a pair of coulters 180 that are mounted to the front of frame 110. Coulters 180 include generally circular cutting blades 182 that are used to cut vegetation along the side of bed 50. Each coulter 180 is mounted to frame 110 via a support bracket 184 mounted to the front frame 110. An adjustable support 186 couples coulter 180 to support bracket 184. Adjustable support 186 is adjustably mounted on support bracket 184 to allow coulter 180 to be laterally displaced along the front of frame 110. This lateral displacement allows coulters 180 to be adjusted for the width of the particular bed 50 on which mower 100 is being used.

A biasing member 188 in the form of a helical spring biases cutting blades 182 to an operating position. Biasing member 188 prevents rock damage to coulter 188 by allowing coulter 188 to ride over a rock (not shown), and then return to its operating position after riding over the rock.

Although the invention is illustrated and described herein with reference to specific embodiments, the invention is not intended to be limited to the details shown. Rather, various modifications may be made in the details within the scope and range of equivalents of the claims and without departing from the invention. For example, although illustrated with the power input to the rotating blades provided via a transfer mechanism including gear 122 that receives power from coupling 104, which in turn receives power from a tractor or other vehicle for pulling the mower, the rotational power may be provide by other means, such as a separate internal combustion engine mounted on the mower. Any means known in the art for providing rotational force to the mower blades may be incorporated.

What is claimed:

1. A high-lift mower comprising:
a frame;
at least two wheels disposed along opposite sides of the frame and having a space between them;
blade rotation means, mounted to the frame, for providing a rotational force relative to the frame;
a blade assembly coupled to the blade rotation means, wherein the blade assembly comprises a plurality of cutting blades, each of the plurality of blades including a front face having a cutting blade and a rear face disposed away from the front face, the rear face having a lift portion; and
a roller assembly adjustably coupled to the frame for, upon engagement with a surface located in the space between the pair of wheels, maintaining the blade assembly a predetermined distance above the surface.

2. The high-lift mower according to claim 1, further comprising at least one circular cutting blade rotationally coupled to the frame.

3. The high-lift mower according to claim 2, wherein the at least one circular cutting blade is laterally displaceable along the frame.

4. The high-lift mower according to claim 2, wherein the at least one circular cutting blade is coupled to a front portion of the frame.

5. The high-lift mower according to claim 1, wherein the roller assembly is adjustably coupled to a rear of the frame.

6. The high-lift mower according to claim 1, wherein the roller assembly comprises a support member pivotally coupled to the frame and an adjuster having a first end rotatably coupled to the frame and a second end threadably coupled to the support member.

7. The high-lift mower according to claim 1, wherein the frame comprises a side wall and wherein the sidewall includes a discharge opening.

8. The high-lift mower according to claim 1, wherein the frame comprises a generally helical shape.

9. A high-lift mower blade comprising:
a first end portion adapted to be coupled to a mower;
a middle portion extending downward from the first end portion at an oblique angle relative to the first end portion; and
a second end portion extending obliquely away from the middle portion and generally parallel to the first end portion, wherein the second end portion comprises a front face having a cutting blade and a rear face including a lift portion that extends upwardly therefrom.

10. The high-lift mower blade according to claim 9, wherein middle portion further comprises a rear face and the lift portion extends across the rear face of the middle portion.

11. The high-lift mower blade according to claim 9, wherein the lift portion comprises a generally linear lift portion rear face.

12. The high-lift mower blade according to claim 9, wherein the lift portion comprise a flat face.

13. A roller assembly for mounting to a frame of a high-lift mower, the mower comprising the frame, one or more rotating blades mounted beneath the frame, and at least two wheels disposed along opposite sides of the frame and spaced apart from one another a first distance sufficient to accommodate a raised bed surface between them, the roller assembly comprising:
one or more arms for coupling to the frame;
a horizontal support bar coupled to the one or more arms,
a roller rotatably coupled to the support bar for engaging the raised bed surface;
a height adjustment mechanism for varying a height of the roller relative to the rotating blades for setting a minimum distance between the raised bed surface and the rotating blades.
